(19) United States
(12) Patent Application Publication
(10) Pub. No.: US 2026/0359488 A1
(43) Pub. Date: Nov. 12, 2026

(54) Policy-Governed Agentic Action Control for AI Systems of Action

(71) Applicant: Michael Raymond Cantow, Mahwah, NJ (US)

(72) Inventor: Michael Raymond Cantow, Mahwah, NJ (US)

(21) Appl. No.: 19/714,578

(22) Filed: Jun. 21, 2026

Related U.S. Application Data
(60) Provisional application No. 63/789,488, filed on Apr. 16, 2025.

(51) Int. Cl. G06F 21/62; G06F 21/60

(52) U.S. Cl. CPC G06F 21/629; G06F 21/604; G06F 2221/2141

(57) ABSTRACT

A policy-governed agent execution system evaluates multiple policy dimensions before an AI agent receives context or executes an action. A policy context builder assembles tenant AI enablement status, license tier, user permissions, and party role group membership. A pre-context permission gate terminates the request before execution-object data is loaded when permissions fail. A payload parameter filter discards non-allowlisted parameters and requires additional credentials for tier-restricted parameters. A capability surface generator determines permitted tools, directives, and functions based on party role, license tier, and tenant policy, generating different AI capability sets for different user classes. A handler registry, directive whitelist, and party-specific mutation gate govern which AI-proposed actions can execute. An approval routing module stores approval-required mutations as structured proposals. The system instantiates each agent within a policy-evaluated execution envelope.

### CROSS-REFERENCE TO RELATED APPLICATIONS

This application claims the benefit of U.S. Provisional Application No. 63/789,488, filed Apr. 16, 2025, the entire disclosure of which is incorporated herein by reference.

### FIELD OF THE INVENTION

The present invention relates to policy control architectures for AI agent systems, and more specifically to a system and method that evaluates tenant policy, license tier, user permissions, party role group membership, payload parameters, directive whitelists, handler registries, and approval requirements before an AI agent receives context, tools, or execution authority.

### BACKGROUND OF THE INVENTION

AI agent systems increasingly perform actions in enterprise environments: modifying records, triggering workflows, generating content, scheduling tasks, and coordinating multi-party processes. As AI agents move from advisory roles to action roles, the governance problem becomes critical.

Ungoverned agent access. Most AI agent frameworks give agents full access to tools and data once invoked. The agent sees everything the user can see, can call any tool registered in its environment, and can execute any action the tool permits. Policy enforcement happens at the tool layer (API permissions) or not at all.

Tool-level permissions are insufficient. Restricting agents by API-level permissions does not address the deeper governance questions: Should this tenant have AI at all? Should this user's license tier expose this capability? Should this parameter be forwarded from the client to the agent? Should this mutation require human approval? Should this party role group see different AI capabilities than another? These are policy questions that exist above the tool layer.

No pre-context policy evaluation. In conventional systems, the agent is instantiated, receives context (potentially sensitive data), and then encounters permission checks at execution time. By then, the data has already been transmitted to the language model. A policy architecture should evaluate permissions before context is constructed, not after.

What is needed is a policy control plane that sits between the action request and the agent, evaluating multiple policy dimensions before the agent receives any context, any tools, or any execution authority.

### SUMMARY OF THE INVENTION

### What This Invention Controls: Agent Action Authority

The central technical problem addressed by this invention is governing what an AI agent can see, what it can do, what tools it can access, and what mutations it can execute, before the agent is instantiated. The invention's unique contribution is a policy-governed agent adapter that builds a multi-dimensional policy context (tenant enablement, license tier, user permissions, party role, payload parameters) and uses it to construct a policy-evaluated execution envelope: the agent is instantiated with only the context, parameters, tools, and capabilities that survive the policy evaluation.

This approach is necessarily rooted in computer technology because the specific combination of pre-context permission gating, allowlist-based parameter filtering with tier-stratified restricted parameters, capability surface generation from multi-dimensional policy context, and handler/directive/party mutation gating produces a technical improvement in AI agent architectures: policy enforcement before context construction, not after action execution.

In one embodiment, a central agent adapter acts as the pre-execution policy control plane, while additional local policy modules within individual agents enforce agent-specific directive, handler, party, or approval rules. The distributed enforcement is coordinated through the central adapter's pre-instantiation policy evaluation.

The following policy dimensions and enforcement mechanisms are representative embodiments; other policy attributes, tier structures, allowlist configurations, or domain-specific equivalents may be used without departing from the invention.

### BRIEF DESCRIPTION OF THE DRAWINGS

FIG. 1 is a block diagram illustrating the policy-governed agent execution system architecture.

FIG. 2 is a flowchart illustrating the pre-context policy evaluation sequence.

FIG. 3 is a diagram illustrating the payload parameter filter with allowlist and tier-restricted parameters.

FIG. 4 is a block diagram illustrating capability surface generation for different user classes.

FIG. 5 is a flowchart illustrating policy-gated action execution through handler registry, directive whitelist, and party mutation gate.

FIG. 6 is a diagram illustrating the approval routing flow for human-acceptance-required mutations.

FIG. 7 is a comparison diagram contrasting ungoverned, tool-gated, and policy-governed agent architectures.

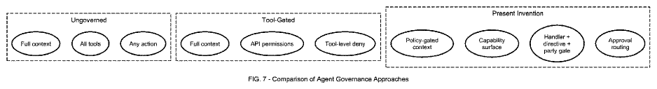

### DETAILED DESCRIPTION OF THE INVENTION

### System Architecture Overview

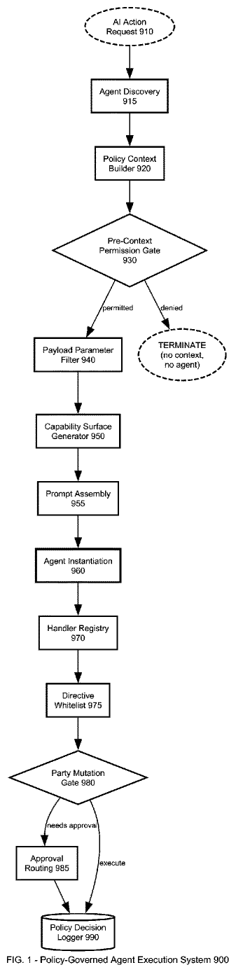

Referring to FIG. 1, the policy-governed agent execution system 900 comprises an agent request receiver 910, an agent discovery module 915, a policy context builder 920, a pre-context permission gate 930, a payload parameter filter 940, a capability surface generator 950, a prompt assembly module 955, an agent instantiation module 960, a handler registry 970, a directive whitelist 975, a party-specific mutation gate 980, an approval routing module 985, and a policy decision logger 990.

### Agent Request Receiver and Discovery

The agent request receiver 910 receives AI action requests from client connections (WebSocket messages in the preferred embodiment). Each AI action request identifies an agent type (a short string identifier) and a requesting user. The agent type identifier is treated as untrusted client input and is validated through the discovery process described below.

The agent discovery module 915 identifies the agent class corresponding to the agent type by traversing a directory tree of agent definitions. The module converts the agent type identifier to a class name by naming convention: snake_case agent type identifiers are converted to PascalCase with an “Agent” suffix; lowerCamelCase agent type identifiers are capitalized at the first character. The module detects the agent's scope category for the given agent type (stage-scoped, journey-scoped, or system-scoped) based on the agent's filesystem directory location. Stage-scoped agents are routed through a stage controller; system and journey agents are instantiated directly.

### Policy Context Builder

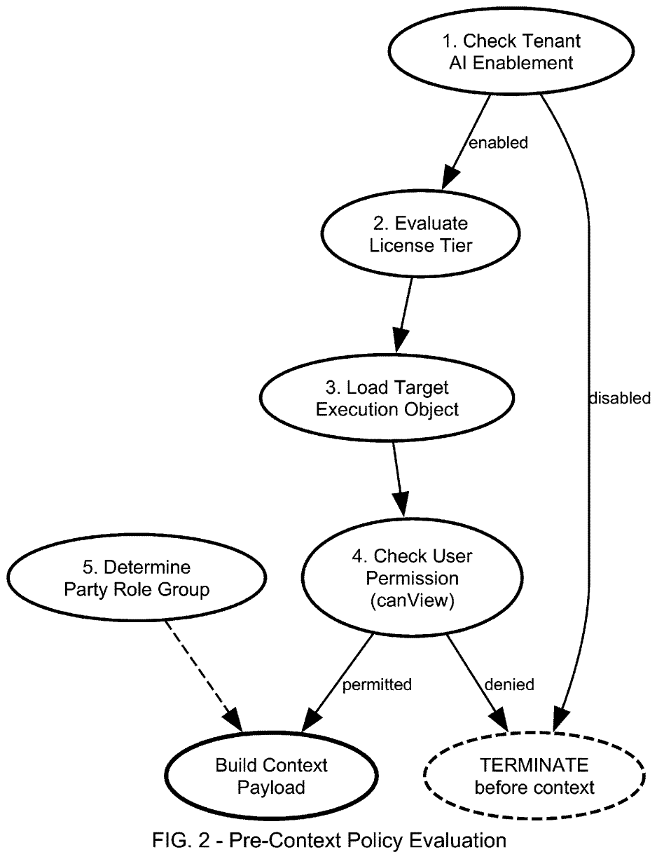

Referring to FIG. 2, the policy context builder 920 assembles a multi-dimensional policy context for each AI action request. The policy context comprises:

Tenant AI enablement. The builder queries the requesting user's tenant organization membership and retrieves the AI authorization flag. If the flag is inactive, the policy context marks AI as disabled for this tenant.

License tier. The builder evaluates whether the requesting user is a paid user and, if applicable, whether the user's profile includes a premium tier designation (e.g., a platinum capability flag). The license tier determines which parameter subsets and capability surfaces are available.

User permission against target execution object. The builder loads the target execution object (if the request references one) and evaluates the requesting user's permission level via a party-aware permission evaluator. The permission evaluator determines whether the user belongs to a first party role group or second party role group and routes evaluation through the corresponding permission checker.

Party role group membership. The builder records whether the requesting user is a first-party member (managing organization) or second-party member (participating organization). This party identity is used downstream by the capability surface generator and the party-specific mutation gate.

### Pre-Context Permission Gate

The pre-context permission gate 930 evaluates the policy context before any execution-object data is loaded into an AI context payload. If the requesting user does not have at least view-level permission on the target execution object, the gate terminates the request. No context payload is constructed, no data is transmitted to a language model, and no agent is instantiated.

This pre-context evaluation is the key architectural distinction from conventional agent systems, where permission is checked at action execution time, after the agent has already received the full data context. By gating before context construction, the system prevents data exposure to agents operating on behalf of unauthorized users.

### Action-Type Permission Tiering

Each registered action handler reachable through the agent execution envelope carries a permission-tier identifier drawn from an enumerated set of permission tiers. The dispatch boundary, before invoking a resolved action handler, consults the permission-tier identifier of the resolved handler and verifies that the requesting user holds at least the corresponding permission tier. In the preferred embodiment, the permission-tier identifier is materialized as a set of action-type identifiers requiring a host-level edit credential, with all other action types satisfied by an authorized-member credential. The mapping is enforced at the dispatch boundary, independent of any logic within the handler implementation, such that a handler implementation cannot relax its required permission tier and a client cannot escalate by invoking a handler under a different name; the permission tier required to invoke a given action is a structural property of the action-type, not a property of the user, the handler implementation, or the requesting client.

### Null-Context Abort Before Model Invocation

The pre-context permission gate is implemented such that a permission failure produces a null context result returned to the agent instantiation module. The agent instantiation module is configured to abort on a null context result before any execution-object data is loaded into a context payload, before any large language model is invoked, and before any agent class is instantiated. The structural property is that there is no code path through which a null context result can produce a probabilistic generative model invocation: a null result returned from the journey-context loader to the agent adapter terminates the request at the adapter, prior to context construction. This eliminates cross-tenant data exfiltration through the model response stream by construction rather than by post-response filtering.

### Payload Parameter Filter

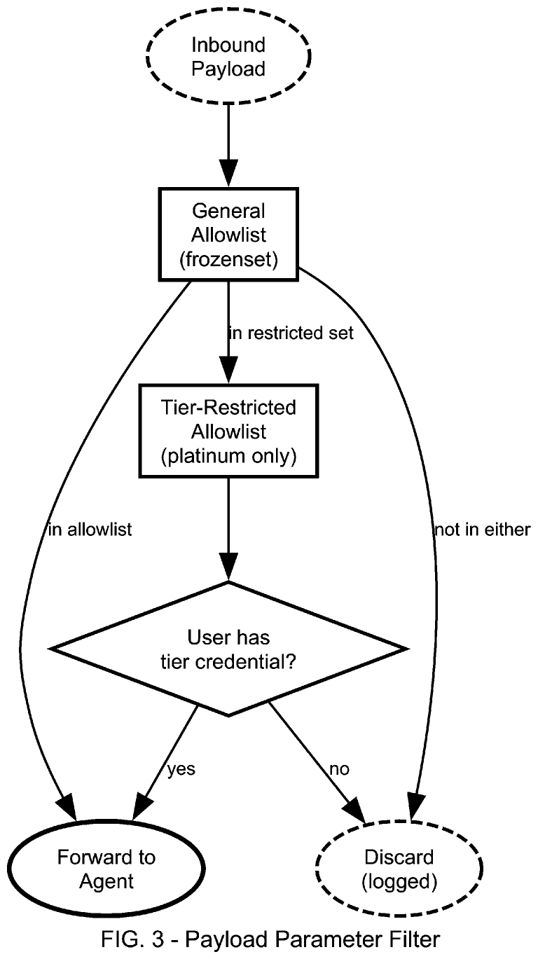

Referring to FIG. 3, the payload parameter filter 940 filters the parameters of the AI action request through a two-tier allowlist:

General allowlist. A first allowlist (a frozenset in the preferred embodiment) enumerates the parameter names that any authorized user may forward to an agent. Parameters not present in this allowlist are silently discarded before agent instantiation. The discarding is logged at a diagnostic level for operational monitoring but does not expose information to the requesting user.

Tier-restricted allowlist. A second allowlist enumerates parameters that require verification of an additional capability credential. In the preferred embodiment, the credential is a premium license tier flag on the user's profile. If the requesting user does not have the required tier, tier-restricted parameters are discarded even if present in the request payload.

The parameter filter prevents arbitrary parameter injection from client-side code. Without it, a client could supply internal state parameters (prompt overrides, retry flags, internal configuration) that bypass the agent's intended operating constraints.

### Capability Surface Generator

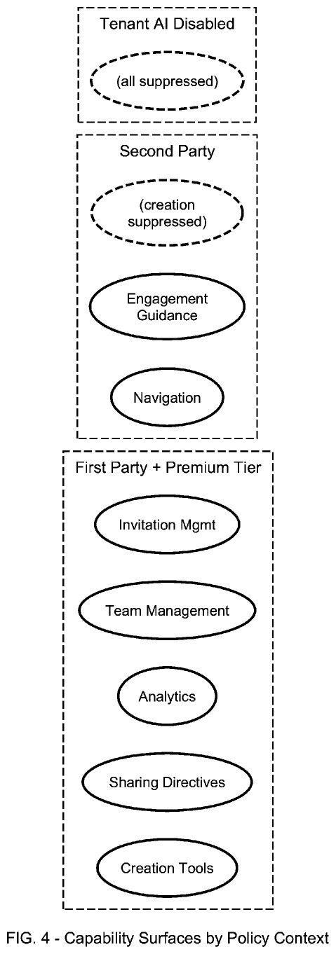

Referring to FIG. 4, the capability surface generator 950 determines the set of AI capabilities exposed to each agent based on the policy context. The capability surface generator operates per agent type: for a given agent type, the generator may produce different permitted capability sets for different requesting users based on the user's party role group, the user's license tier, the user's additional capability credential, and the tenant's AI enablement status.

First-party, qualifying-tier users. The generator exposes a full capability set comprising: creation tools (template and journey creation), sharing directives (invitation generation, email sending, team management), cross-instance analytics, navigation across all accessible execution objects, and AI-driven invitation management.

Second-party users. The generator exposes a restricted capability set comprising: navigation assistance, engagement guidance, and action recommendations scoped to the second party's visible execution objects. Creation, sharing, analytics, and team management capabilities are suppressed. The suppression is implemented at the prompt level: the agent's system prompt does not mention suppressed capabilities, so the underlying language model cannot invoke them.

Tenant-disabled users. The generator suppresses agentic AI action capabilities, and the request is terminated before agent instantiation when tenant policy disables AI execution.

### Prompt Assembly Module

The prompt assembly module 955 generates the agent's system prompt incorporating only the permitted capability set. Two users invoking the same agent type may receive different system prompts based on their respective policy contexts. This ensures the language model operates within the policy-evaluated boundary without relying on post-generation filtering.

### Agent Instantiation Module

The agent instantiation module 960 instantiates the identified agent class with only the permitted context, permitted parameters, and the capability-scoped system prompt. The module passes the policy-evaluated execution envelope to the agent constructor, including: the requesting user identity, the loaded execution object (if permitted), the permission checker, the filtered parameter set, and any agent-specific context derived from the policy evaluation.

In the preferred embodiment, the agent instantiation module operates within a thread pool executor. The module closes stale database connections before and after each agent execution to prevent connection leakage across concurrent invocations.

### Handler Registry

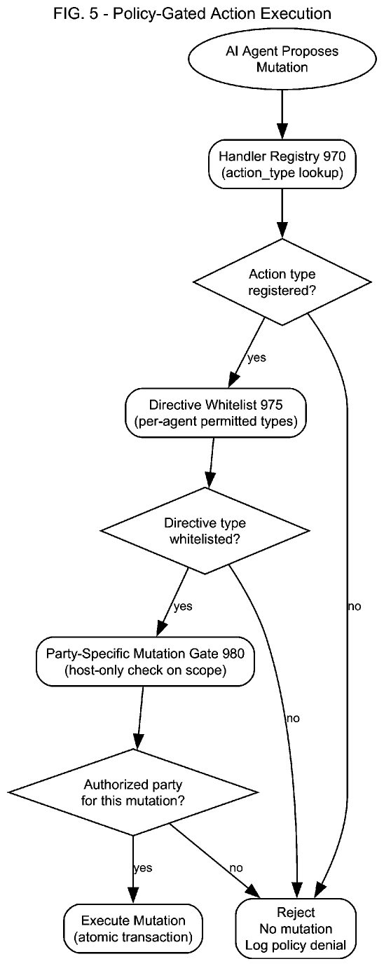

Referring to FIG. 5, the handler registry 970 comprises a dictionary mapping action type identifiers to registered handler functions. When an AI agent proposes a mutation, the system resolves the action type identifier against the registry. If the action type is not registered, the system raises an error and no mutation occurs. This prevents AI agents from executing arbitrary database operations.

### Directive Whitelist

The directive whitelist 975 comprises a predetermined set of permitted directive types for each agent type. When an AI agent generates a candidate directive, the system validates the directive type against the whitelist. Only whitelisted directives are executed. Non-whitelisted directives are rejected without execution.

In the preferred embodiment, the insight analytics agent defines a set of ten permitted directive types (LIST_TEMPLATES, COMPUTE_STATS, CROSS_CORRELATE, CREATE_PIVOT, STAGE_ANALYTICS, LINE_ITEM_ANALYTICS, TEAM_ANALYTICS, RUN_CLASSIFICATION, RUN_REGRESSION, VIEW_SHAP). The dispatch table routes each validated directive to a specific executor function.

### Party-Specific Mutation Gate

The party-specific mutation gate 980 evaluates whether each proposed AI-driven mutation requires first-party-only authorization. In the preferred embodiment, scope-related mutations (proposed scope table updates and scope question updates) require the requesting user to pass a first-party edit check. Other mutation types (discovery answers, meeting records, deployment tasks, goals, commit records) are permitted by any authorized member of either party role group.

### Approval Routing Module

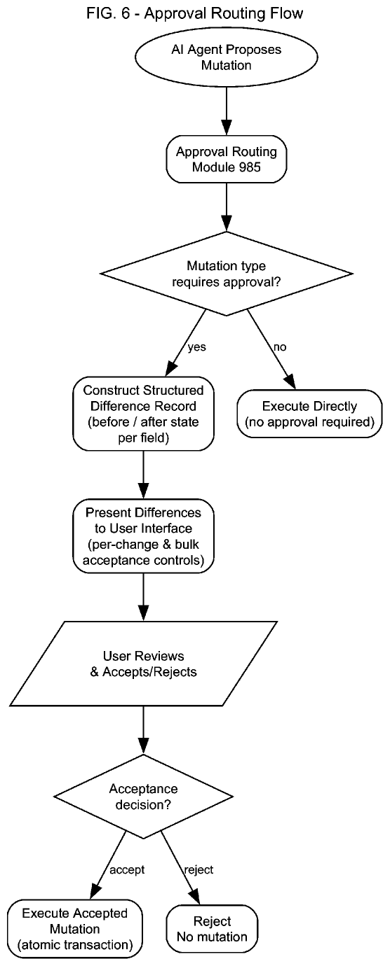

Referring to FIG. 6, the approval routing module 985 handles mutations designated as requiring human acceptance. The module implements the acceptance flow before execution: when an AI agent proposes a change that requires approval, the module stores the proposed change as a structured difference record (comprising before-state and after-state for each affected field), presents the difference records through the user interface with per-change and bulk acceptance or rejection controls, and executes the mutation only upon explicit user acceptance. The acceptance flow before execution prevents AI-proposed mutations from reaching the database until the authorized user has reviewed each affected field and explicitly accepted the change.

The acceptance flow before execution is required only for the subset of mutation types that the system configuration designates as approval-required. For non-approval-required mutations, the proposed mutation is executed directly upon passing the handler registry and party-specific mutation gate checks, without an acceptance flow.

### Policy Decision Logger

The policy decision logger 990 records, for each AI action request: the policy evaluation result (comprising the tenant status outcome, license tier outcome, user permission outcome, and party role determination), the capability surface generated, the action permitted or denied, and the execution outcome. The policy evaluation result is recorded as a structured log entry keyed by the AI action request identifier, enabling later audit of AI governance decisions and forensic reconstruction of why a specific agent received specific capabilities.

Each policy evaluation result includes a timestamp, the requesting user identifier, the agent type, and the boolean outcome of each policy dimension check. The policy evaluation result enables retrospective analysis of denied requests (to surface policy misconfigurations) and accepted requests (to verify that capability surfaces match policy expectations).

### Stress Behavior

High concurrency. Multiple AI action requests may arrive simultaneously. The policy context builder and permission gate evaluate each request independently. The thread pool executor manages concurrent agent instantiations. Database connection cleanup prevents resource leakage.

Policy changes mid-session. If a tenant's AI enablement flag or a user's license tier changes while an agent session is active, the change takes effect on the next AI action request. In-flight agent executions complete under the policy context evaluated at their instantiation time.

Unknown agent types. If the agent discovery module cannot find an agent class matching the requested agent type, the request is terminated with no agent instantiation and no context construction.

Acceptance flow before execution timeout. If an authorized user does not respond to an acceptance flow before execution within a configured timeout period, the proposed mutation is discarded and not executed.

Acceptance flow before execution audit. Each acceptance flow before execution is recorded in the policy decision logger with the proposed mutation identifier, the user identity, the acceptance or rejection outcome, and a timestamp.

Policy evaluation result caching. The policy evaluation result is recomputed for each AI action request and is not cached across requests, ensuring policy changes take effect on the next request.

Policy evaluation result serialization. The policy evaluation result is serialized into the policy decision log entry as a structured record enabling retrospective query by user, by tenant, or by time period.

### Reused Term References

The following short references reinforce the terminology used in the claims and reused throughout this specification.

Policy evaluation result.

Each policy evaluation result.

Acceptance flow before execution.

Each acceptance flow before execution.

### Non-Obvious Combination Effects

1. Pre-context policy evaluation. Individual policy checks (permission, tier, allowlist) are known. Evaluating all policy dimensions before any context is constructed, and terminating the request before data reaches the language model, is a non-obvious architectural choice. Conventional systems check permissions at action time, after the model has already seen the data.
2. Policy-scoped capability surfaces. Role-based access control is known. Generating different AI capability sets (different system prompts, different tool availability, different directive sets) from the same agent type based on multi-dimensional policy context is not the obvious combination. The agent type is constant; the capability surface varies by policy.
3. Distributed enforcement with central orchestration. The adapter evaluates pre-instantiation policy centrally, while individual agents enforce local policy (directive whitelists, handler registries, party mutation gates). This two-layer architecture provides defense-in-depth without requiring all policy logic to reside in one location.

### Improvement Over Prior Art

| | Ungoverned | Tool-Gated | |
|---|---|---|---|
| Property | Agents | Agents | Present Invention |
| Context access | Full | Full | Policy-gated (pre- |
| | | | context) |
| Parameter | None | None | Allowlist with tier |
| control | | | stratification |
| Capability | Fixed per | Fixed per | Dynamic per |
| surface | agent | agent | policy context |
| Mutation | Tool | Tool | Handler registry + |
| control | permissions | permissions | directive whitelist + |
| | | | party gate |
| Approval routing | None | None | Structured proposal |
| | | | with accept/reject |
| Policy logging | None | Tool-level | Multi-dimensional |
| | | logs | policy decision log |

### Multiple Embodiments

Enterprise sales. The managing organization's sales team gets full AI capabilities including deal creation, content personalization, scheduling, and analytics. The participating buyer organization gets navigation guidance only.

Healthcare. The care team gets full clinical AI capabilities. The patient or family gets scoped communication and progress guidance.

Consulting. The consulting firm gets project management AI. The client gets status visibility and feedback capabilities.

Implementation. The implementation provider gets deployment AI with scheduling and dependency management. The customer gets milestone tracking and acceptance capabilities.

Multi-tier licensing. A basic tier gets core AI assistance. A premium tier gets advanced capabilities (prompt customization, analytics, cross-journey intelligence). The policy layer enforces tier boundaries without requiring separate agent implementations.

### Computer-Implemented Method Embodiment

In one embodiment, the present invention is embodied as a computer-implemented method for policy-governed AI agent execution. The computer-implemented method is executed on one or more processors and one or more non-transitory computer-readable memory devices storing instructions that, when executed by the one or more processors, cause the one or more processors to perform the steps of the computer-implemented method. The computer-implemented method may be deployed on physical servers, virtual servers, cloud-hosted compute instances, or hybrid configurations. Each step of the computer-implemented method corresponds to a structural component of the system 900 described in the preceding sections and may be implemented as a software module, a database transaction, a network message handler, or a combination thereof. The computer-implemented method does not require specialized hardware; it executes on conventional computing infrastructure including one or more web servers, application servers, database servers, and a network layer providing WebSocket connectivity between client devices and the application servers.

Step 1 of the computer-implemented method—Receive an AI action request. The computer-implemented method receives an AI action request through a network connection (a WebSocket message in the preferred embodiment, with a REST request alternative). Each AI action request identifies an agent type (a string identifier) and the requesting user (resolved from the authenticated session context).

Step 2 of the computer-implemented method—Assemble policy context. The computer-implemented method assembles a policy context comprising at least four policy dimensions: (a) tenant AI enablement status, derived from a tenant organization record associated with the requesting user; (b) license tier of the requesting user, derived from the user's profile and the user's tenant organization's license level; (c) user permissions against a target execution object, evaluated by a party-aware permission evaluator that resolves the requesting user to a first party role group or a second party role group and applies the appropriate party-specific permission checker; and (d) party role group membership of the requesting user.

Step 3 of the computer-implemented method—Evaluate policy context before loading execution-object data. The computer-implemented method evaluates the policy context before loading any execution-object data into an AI context payload. If the tenant AI enablement status is inactive, or if the user permission evaluation indicates the requesting user does not have at least view-level permission on the target execution object, the computer-implemented method terminates the AI action request. Termination occurs before construction of any AI context payload, before transmission of data to a language model, and before instantiation of the agent. No execution-object data is exposed under failed policy evaluation.

Step 4 of the computer-implemented method—Filter request parameters through an allowlist. The computer-implemented method filters the parameters of the AI action request through a parameter allowlist and discards parameters not present in the allowlist. The filtering is performed before agent instantiation. Discarded parameters are not exposed to the agent and do not appear in any context payload transmitted to a language model. In the preferred embodiment, the parameter allowlist is implemented as a frozen set enumerating permitted parameter names.

Step 5 of the computer-implemented method—Verify additional capability credential for tier-restricted parameters. For parameters that the system designates as tier-restricted, the computer-implemented method verifies an additional capability credential of the requesting user before forwarding the parameter to the agent. The additional capability credential is a license-tier attribute persisted on the requesting user's profile, indicating eligibility for advanced capabilities. If the additional capability credential is not present, tier-restricted parameters are discarded even if otherwise present in the request payload.

Step 6 of the computer-implemented method—Determine the permitted capability set. The computer-implemented method determines the permitted capability set for the AI action request based on the policy context. The permitted capability set varies across users invoking the same agent type: a requesting user belonging to the first party role group with a qualifying license tier receives a first permitted capability set that exposes creation tools, sharing directives, analytics capabilities, and team management functions; a requesting user belonging to the second party role group receives a second permitted capability set that exposes navigation assistance and engagement guidance and suppresses creation tools, sharing directives, and analytics capabilities; a requesting user whose tenant has AI disabled receives a third permitted capability set in which agentic AI action capabilities are suppressed entirely.

Step 7 of the computer-implemented method—Generate agent system prompt incorporating the permitted capability set. The computer-implemented method generates an agent system prompt incorporating only the permitted capability set determined in step 6. Two users invoking the same agent type may receive different system prompts based on their respective policy contexts. The agent system prompt does not mention capabilities outside the permitted capability set, ensuring the underlying language model cannot invoke them even by hallucination.

Step 8 of the computer-implemented method—Instantiate the agent. The computer-implemented method instantiates the agent class identified by the agent discovery module with only the permitted context, the permitted parameters, the capability-scoped system prompt, and any agent-specific context derived from the policy evaluation. The instantiation occurs within a thread pool executor in the preferred embodiment, and stale database connections are closed before and after instantiation to prevent connection leakage across concurrent invocations.

Step 9 of the computer-implemented method—Route each proposed AI-driven mutation through the handler registry, the directive whitelist, and the party-specific mutation gate. When the instantiated agent proposes a mutation, the computer-implemented method routes the proposed mutation through (a) a handler registry that validates the mutation's action type identifier is registered, (b) a directive whitelist that validates the directive type is permitted for the agent type, and (c) a party-specific mutation gate that evaluates whether the mutation type is restricted to a specific party role group. Mutations failing any of the three checks are rejected without execution.

Step 10 of the computer-implemented method—Route approval-required mutations to an acceptance flow before execution. For mutations designated as requiring human acceptance, the computer-implemented method stores the proposed mutation as a structured proposal (comprising before-state and after-state for each affected field), presents the structured proposal to an authorized user for acceptance or rejection, and executes the mutation only upon explicit acceptance.

Step 11 of the computer-implemented method—Log the policy evaluation result, capability surface, and action outcome. The computer-implemented method records, for each AI action request: the policy dimensions evaluated (tenant status, license tier, user permission, party role), the capability surface generated, the mutation type if applicable, the action permitted or denied, and the execution outcome. The recorded log enables audit of AI governance decisions and forensic reconstruction of why a specific requesting user received a specific capability surface.

### Agent Type Resolution Detail

An agent type, as used herein, is a short string identifier that the AI action request uses to designate which AI agent class should handle the request. The agent type identifier is typically a snake_case or lowerCamelCase string (for example, ‘ai_design_assistant’, ‘aiJourneyCreator2’, ‘aiPivotAssistant’). The agent type identifier is treated as untrusted client input and is therefore validated through a deterministic discovery mechanism rather than executed as a class name.

The agent discovery module enumerates a predefined directory tree of agent class definitions. For each requested agent type, the discovery module performs a filesystem walk of the predefined directory tree to locate a Python module file whose filename matches the agent type identifier. If no matching module is found, the discovery module returns no agent class, and the AI action request is terminated without further evaluation.

When a matching module is found, the discovery module converts the agent type identifier to a class name by naming convention: a snake_case identifier such as ‘ai_design_assistant’ is converted to a PascalCase class name with an “Agent” suffix (e.g., ‘AiDesignAssistantAgent’); a lowerCamelCase identifier such as ‘aiJourneyCreator2’ is converted to a class name by capitalizing the first character (e.g., ‘AiJourneyCreator2’). The discovery module then imports the matched module and retrieves the converted class name via attribute lookup. If the class is not present in the matched module, the discovery module returns no agent class, and the AI action request is terminated.

The agent discovery module further classifies the agent type into a scope category based on the agent's filesystem directory location: stage-scoped agents reside under a stage-specific directory and are routed through a stage controller during instantiation; journey-scoped agents reside under a journey-agent directory and are instantiated directly; system-scoped agents reside under a system-agent directory and are also instantiated directly. The scope category determines which downstream initialization parameters are passed to the agent constructor.

In some embodiments, an agent type identifier is registered with auxiliary metadata in an agent registry, including the agent's required permission level, the agent's required license tier, the agent's allowed directive whitelist, and any agent-specific configuration. The auxiliary metadata is consulted during policy context assembly to ensure the agent type is permitted for the requesting user before the agent discovery walk is performed. The auxiliary metadata may be expressed as a configuration file, a database table, or in-code constants.

### Requesting User Resolution Detail

The requesting user is the authenticated principal of the AI action request, resolved from the network session context. In the preferred embodiment, the AI action request arrives via a WebSocket consumer that has previously authenticated the user via session middleware. The requesting user is therefore available as a user model instance with associated tenant organization membership records, guest membership records, profile records, and permission attributes.

The requesting user is used by the policy context builder in multiple capacities: (1) the user's tenant organization membership is queried to determine tenant AI enablement; (2) the user's profile is queried to determine the user's individual license tier and the user's additional capability credentials; (3) the user's membership records (host membership and guest membership) are queried to determine the user's party role group membership relative to a target execution object; (4) the user's permission level on the target execution object is evaluated via the party-aware permission evaluator.

The requesting user identifier is also persisted alongside any applied mutation as the acting-user reference in the activity event log, enabling subsequent audit and party-attribution.

If the requesting user cannot be resolved (for example, due to an expired session, a malformed token, or a missing authentication header), the AI action request is terminated at the receiver before any policy context is built and before any agent type resolution is attempted. The terminated request is logged with the unauthenticated indicator at the policy decision logger.

In a guest invitation flow, the requesting user may be a newly-onboarded guest user whose first AI action request arrives at the moment of accepting an invitation link. In this case, the requesting user is resolved through the invitation acceptance handler, which creates the guest membership record and then completes the AI action request under the newly-created membership context.

### Additional Capability Credential Detail

The additional capability credential, as used herein, is an attribute persisted on the requesting user that designates eligibility for one or more advanced or restricted capabilities. The additional capability credential is verified by the policy context builder before tier-restricted parameters are forwarded to an agent and before tier-restricted capabilities are included in the permitted capability set.

In the preferred embodiment, the additional capability credential is implemented as a boolean attribute on the user's profile model (e.g., ‘isCustomerNodePlatinum’). The boolean is set to true for users whose subscription includes premium-tier capabilities and false otherwise. The boolean is checked at policy evaluation time. Additional embodiments may implement the additional capability credential as a string-valued tier identifier (e.g., ‘tier=“basic”’, ‘tier=“pro”, ‘tier=“enterprise”’), as a numeric tier level, as a multi-valued attribute encoding feature flags, or as a reference to a separate entitlement record carrying expiration dates and feature lists.

The additional capability credential is distinct from the basic permission level on a target execution object. The additional capability credential determines what categories of capabilities the requesting user may access in principle; the basic permission level determines whether the requesting user may access a specific execution object's content. A requesting user may carry the additional capability credential but lack permission on a particular execution object (in which case execution-object-related capabilities are suppressed by the pre-context permission gate), or carry the basic permission level on a particular execution object but lack the additional capability credential (in which case tier-restricted capabilities are suppressed by the capability surface generator).

The additional capability credential check is performed before tier-restricted parameters are forwarded to the agent and before the permitted capability set is finalized. If the additional capability credential is absent, tier-restricted parameters present in the request payload are discarded by the payload parameter filter, and tier-restricted capabilities are removed from the permitted capability set before the agent system prompt is generated.

Examples of tier-restricted parameters governed by the additional capability credential include: prompt customization parameters that allow advanced users to override default agent prompts, advanced analytics parameters that grant access to cross-instance benchmarking, and integration parameters that enable agent execution against third-party services. Examples of tier-restricted capabilities governed by the additional capability credential include access to predictive analytics, access to cross-journey insight directives, access to outcome modeling tools, and access to data export utilities.

### Permitted Capability Set Detail

The permitted capability set is the policy-evaluated set of tools, directives, and functions that the AI agent is authorized to invoke during the execution of an AI action request. The permitted capability set is constructed by the capability surface generator from the policy context dimensions (tenant AI enablement, license tier, user permissions, party role group membership) and is unique to the combination of requesting user and AI action request.

The permitted capability set is enforced at three boundaries: (1) the agent system prompt boundary, where capabilities outside the permitted capability set are omitted from the agent's system prompt so the language model does not learn of them; (2) the handler registry boundary, where mutation handlers corresponding to capabilities outside the permitted capability set are not invokable; and (3) the directive whitelist boundary, where directives outside the permitted capability set are rejected at validation time.

In the preferred embodiment, the permitted capability set varies systematically across three principal user classes:
First party role group with qualifying license tier. The permitted capability set includes creation tools (template creation, journey creation, content creation), sharing directives (invitation generation, email transmission, team member addition, invitation revocation), analytics capabilities (cross-instance benchmarking, outcome correlation, asymmetry detection, predictive scoring), team management functions, and full navigation across all accessible execution objects.
Second party role group. The permitted capability set is restricted to navigation assistance and engagement guidance scoped to execution objects visible to the requesting user. Creation tools, sharing directives, analytics capabilities, and team management functions are removed from the permitted capability set.
Tenant with AI disabled. The permitted capability set is empty for agentic AI action capabilities; only passive read-only navigation may remain. Equivalent treatment is applied when the requesting user's session is unauthenticated or when the user lacks any organization membership.

Additional permitted capability set variants are produced for additional user classes, such as first-party members without the qualifying additional capability credential (in which case tier-restricted creation or analytics tools are removed from the otherwise-full permitted capability set), second-party administrators (whose permitted capability set may include limited invitation-management capabilities for invitations within the second party role group), and policy-disabled users on specific journeys (whose permitted capability set is reduced for that journey only).

The permitted capability set is computed at AI action request time and is not cached across requests. Every AI action request triggers a fresh policy context evaluation and a fresh permitted capability set computation, ensuring that changes to policy attributes take effect on the next AI action request without requiring agent restart or session termination.

The construction of the permitted capability set is deterministic with respect to the policy context: given the same policy context inputs, the capability surface generator produces the same permitted capability set. This determinism is necessary for audit traceability: every policy decision can be reconstructed by replaying the policy context evaluation against the capability surface generator's deterministic logic.

### DEFINITIONS

“Policy context”: A multi-dimensional evaluation comprising tenant AI enablement, license tier, user permissions, party role group membership, and other policy attributes assembled before agent instantiation.

“Pre-context permission gate”: A control point that evaluates user permissions before any execution-object data is loaded into an AI context payload, terminating unauthorized requests before data exposure.

“Payload parameter filter” (also “parameter allowlist”): A filtering mechanism that discards non-allowlisted parameters from AI action requests before agent instantiation.

“Capability surface”: The set of tools, directives, functions, and capabilities exposed to an AI agent, determined by the policy context and potentially different for different users invoking the same agent type.

“Policy-evaluated execution envelope”: The combination of permitted context, permitted parameters, and capability-scoped system prompt within which an AI agent operates.

“Handler registry”: A mapping of action type identifiers to registered handler functions, restricting AI agents to a defined set of permissible mutations.

“Directive whitelist”: A predetermined set of directive types permitted for a given agent type.

“Party-specific mutation gate”: A control mechanism that restricts specified mutation types to members of a specific party role group.

“Approval routing”: A flow that stores proposed mutations as structured proposals for human acceptance before execution.

“Policy decision logger”: A component recording the policy evaluation, capability surface, and action outcome for each AI action request.

“Agent adapter” (also “policy control plane”): The central orchestrator that evaluates policy, filters parameters, generates capability surfaces, and instantiates agents within policy-evaluated execution envelopes.

*[End of Specification]*

### Extended Detailed Description

### Agent Scope Category Detection Architecture

The agent scope category detection logic classifies each agent into one of three scope categories: stage-scoped, journey-scoped, or system-scoped. The classification is performed by the agent discovery module at the moment of agent class loading, using the agent's filesystem location as the classification signal.

Scope category SC-1—Stage-scoped agents. Stage-scoped agents reside under a stage-agent directory in the agent module tree (in the preferred embodiment, a directory named “StageAgents” under the agent root). Stage-scoped agents operate within the context of a specific execution-instance stage; they require the stage object, the stage-scoped permissions, and the stage broadcast group at instantiation. Stage-scoped agents are routed through a stage controller that mediates between the Web Socket consumer and the agent's lifecycle methods.

Scope category SC-2—Journey-scoped agents. Journey-scoped agents reside under a journey-agent directory (in the preferred embodiment, a directory named “JourneyAgents” or directly under the agent root). Journey-scoped agents operate at the journey level, accessing data across multiple stages of one execution instance. Journey-scoped agents are instantiated directly by the agent adapter without a stage controller intermediary.

Scope category SC-3—System-scoped agents. System-scoped agents reside under a system-agent directory or at the agent root. System-scoped agents operate at the user or tenant level, accessing data across multiple execution instances within the user's tenant scope. System-scoped agents are instantiated directly with the user, tenant organization, and tenant-scoped permissions but without an execution instance reference.

The scope classification determines the agent instantiation parameters: stage-scoped agents receive (cNode, cNodeStage, user, permissions); journey-scoped agents receive (cNode, user, permissions); system-scoped agents receive (user, organization, permissions). The classification also determines the lifecycle handler: stage-scoped agents are dispatched through the stage controller's update-type-based routing; journey- and system-scoped agents are dispatched through the agent adapter's chat-agent routing.

### Stage Controller Routing Detail

The stage controller is instantiated per-WebSocket-connection per-execution-instance. The controller captures the channel layer's send and group-send callables, the consumer's channel name, the instance group name, the target execution instance, the target stage, the requesting user, and the permission checker. These captured references are forwarded to dynamically loaded agent classes during agent instantiation.

The stage controller exposes a single public handler method that accepts an inbound WebSocket message addressed to a stage agent. The handler method extracts the agent identifier, the update type, and the payload from the message. The handler then dispatches based on the update type:

Update type UT-1—Getter. The agent retrieves and returns its current state. For one-time-task agents, the agent runs the task to completion; for custom-getter agents, the agent runs a specialized getter; for chat-based agents, the agent polls its chat state.

Update type UT-2—User message. The agent receives a natural-language user message and produces a response. The message is appended to the agent's chat history.

Update type UT-3—Clear chat. The agent's chat history is cleared. The agent's session-level state is preserved.

Update type UT-4—Send action. The agent receives a structured action and executes it. Actions are agent-specific structured commands.

Update type UT-5—Run task. The agent runs a discrete task. Task definitions are agent-specific.

Update type UT-6—Do action. The agent executes a do-action directive. The do-action pattern supports agents that perform direct database mutations.

The dispatch is explicit (not table-driven): the controller contains a sequence of if/elif branches that route each update type to the appropriate agent method. The explicit dispatch is intentional: it permits the controller to apply policy checks before invoking each agent method, with the policy checks varying by update type.

### License Tier Architecture Detail

The license tier architecture supports five tier categories: Guest, Pro, Enterprise, ProTrial, and EnterpriseTrial. The tier categories are defined as enumeration choices on the tenant organization model. Each tenant organization has exactly one tier assignment, governing the tier-scoped capabilities exposed to all members of the organization.

Tier T-1—Guest. The default tier for first-time users without a paid subscription. Guest tier exposes core read capabilities and limited AI features. Guest tier serves the onboarding pathway: new users explore the platform's capabilities before committing to a paid tier.

Tier T-2—Pro. The first paid tier. Pro tier exposes core AI features, journey creation, content management, and analytics. Pro tier is appropriate for small teams and individual practitioners.

Tier T-3—Enterprise. The advanced tier. Enterprise tier exposes all Pro tier capabilities plus enterprise-class features: advanced analytics, custom integrations, single sign-on, dedicated support, and administrative controls.

Tier T-4—ProTrial. A time-limited preview of Pro tier capabilities. ProTrial users have full Pro access during the trial window; on trial expiration, the tier reverts to Guest unless the user converts to a paid Pro subscription.

Tier T-5—EnterpriseTrial. A time-limited preview of Enterprise tier capabilities. EnterpriseTrial behaves analogously to ProTrial but at the Enterprise capability level.

The tier categories form an ordered hierarchy for capability comparison: higher tiers (Enterprise>Pro>Guest) expose strict supersets of lower tiers' capabilities. Trial tiers carry the capability set of the corresponding paid tier for the duration of the trial.

isCustomerNodePlatinum Flag Detail

In addition to the tenant-scoped license tier, the system supports a user-scoped platinum capability flag. The flag is persisted on the user profile model as a boolean field with default false. The flag is an additional capability credential that grants access to tier-restricted parameters and tier-restricted capabilities orthogonal to the tenant license tier.

The platinum flag is checked at the agent adapter's payload parameter filter step before any agent is instantiated. The check is a simple boolean read on the user profile (with safe defaults if the profile attribute is missing, treating missing-attribute as false). When platinum-tier parameters are present in the request payload, the check is performed; when no platinum-tier parameters are present, the check is short-circuited to avoid the database query.

The platinum flag enables fine-grained capability assignment that does not align with the tenant license tier: a user in a Guest tenant may receive the platinum flag to access specific advanced parameters (e.g., a platform-internal user testing advanced agent features); a user in an Enterprise tenant may NOT have the platinum flag if their specific account has not been granted the additional capability.

The platinum flag is managed by administrative tooling and is not user-settable. Administrative grants and revocations are recorded in the policy decision log for audit.

### Per-Tenant Feature Toggles Detail

The tenant organization model carries several per-tenant feature toggles in addition to the AI authorization flag. The toggles include:

Toggle TG-1—allowGenAIUse. The primary AI authorization flag. Boolean, defaults to true. When false, all GenAI invocations from members of the tenant organization are denied at the pre-context permission gate.

Toggle TG-2—lightningInternalPermissions_engagements. Controls whether internal organization-level permission shortcuts apply to engagement records. Boolean, defaults to true. When false, permissions on engagements default to per-instance permission overrides rather than baseline role permissions.

Toggle TG-3—lightningInternalPermissions_templates. Analogous to TG-2 but for templates.

Toggle TG-4—newOrgMembersCanCreateTemplates. Controls whether newly-added organization members may create new templates. Boolean, defaults to true.

Toggle TG-5—newOrgMembersCanCreateEngagement. Controls whether newly-added organization members may create new engagement instances. Boolean, defaults to true.

The toggles are persisted as boolean fields on the tenant organization model. They are evaluated by the policy context builder at AI action request time when the corresponding capability is requested. The toggles compose with the license tier: a Pro tier organization with allowGenAIUse=false has AI suppressed despite the tier exposing AI capabilities; a Guest tier organization with allowGenAIUse=true has AI invocations gated by the per-tier capability set.

The toggles are user-settable by administrative members of the tenant organization through the organization-settings interface. Toggle changes take effect on the next AI action request from any member of the organization.

### Agent System Prompt Assembly Detail

The agent system prompt is assembled at agent instantiation time by composing structured prompt sections based on the requesting user's policy context. The composed sections vary by tier, party role group, agent-specific state, and tenant-level configuration.

Prompt section PS-1—Role identity. Establishes the agent's identity (e.g., “You are a journey assistant”). The role identity is fixed per agent type and does not vary by policy context.

Prompt section PS-2—Capability enumeration. Enumerates the capabilities the agent may invoke. The enumeration is filtered by the permitted capability set: capabilities not in the permitted capability set are omitted from the enumeration. The filtered enumeration prevents the underlying LLM from learning of unavailable capabilities (and thus from attempting to invoke them, since hallucination is the only way a capability outside the prompt could be invoked).

Prompt section PS-3—Directive schema. Specifies the structured format the agent must use when emitting directives. The schema enumerates the permitted directive types (the directive whitelist for this agent type) and their parameter formats.

Prompt section PS-4—Context. Provides relevant context drawn from the policy-evaluated context payload: the target execution instance summary, the current stage state, the user's recent interactions, and any agent-specific session data.

Prompt section PS-5—Terminology constraints. Enforces terminology rules to prevent semantic confusion across responses (e.g., distinguishing “result” from “status”; constraining stage names to template-scoped references).

Prompt section PS-6—Output style guidance. Specifies the response style (e.g., the Verdict-Evidence-Context-Action narrative pattern for analytical agents).

The composition is per-invocation: two users invoking the same agent type at the same time receive different prompts based on their respective policy contexts. The per-invocation composition ensures the prompt reflects the user's current permitted capability set without requiring per-user agent class definitions.

### Capability Surface Per Party Role Detail

The capability surface generator implements party-role-aware capability differentiation. The generator's primary input is the ‘is_guest_view’ flag (true for second-party members, false for first-party members or for first-party members in present mode), which is passed to the agent constructor as a kwarg.

When ‘is_guest_view’ is false, the generator exposes the first capability set: creation tools (template creation, journey creation, content creation), sharing directives (invitation generation, email transmission, team member management), cross-instance analytics, navigation across all accessible execution objects, AI-driven invitation management, and team management functions.

When ‘is_guest_view’ is true, the generator exposes the second capability set: navigation assistance, engagement guidance, action recommendations scoped to execution objects visible to the requesting user, and progress visualization. The second capability set explicitly suppresses creation tools, sharing directives, analytics capabilities, and team management functions.

The differentiation is implemented at the agent system prompt level: the prompt assembly module branches on the ‘is_guest_view’ flag to compose the appropriate prompt section. The two prompts are structurally identical; they differ in the capability enumeration and in the terminology used to describe the user's relationship to the execution instance (e.g., “your journey” for first-party; “the journey you are participating in” for second-party).

Guest-permissions audits are maintained in the test suite to verify that guest agents do not inadvertently expose host-only data. The audits include negative tests that attempt to invoke host-only capabilities through guest agents and verify the invocations are rejected by the capability surface generator.

### Handler Registry Validation at Registration Time

The handler registry maintains a mapping of action type identifiers to consumer action handler bound methods. The mapping is constructed at consumer-actions class instantiation time from the bound methods of the class. The construction is dictionary-literal assignment: each entry maps a string identifier to the corresponding bound method.

The dictionary-literal construction prevents duplicate registration at the class level: an identifier appearing twice in the literal would shadow the earlier entry without an error. To detect duplicate registrations during development, the test suite includes a registration-uniqueness test that walks the dispatch table and verifies no identifier appears more than once.

The registry is consulted at dispatch time via dictionary key lookup. The lookup returns the bound method, which is invoked with the validated parameter set. Unknown identifiers (not present in the registry) raise a key error, which the dispatch path converts to a structured error response.

The registration pattern supports per-stage and per-agent specialization: each consumer-actions class may register different handlers, and the dispatch table is class-instance-scoped. The pattern enables agent type variation without modifying the dispatch architecture.

### Directive Whitelist Enforcement Detail

The directive whitelist for each agent type is implemented as a frozen set of permitted directive type identifiers, defined as a class-level constant on the agent class. The frozen set is the canonical source for the directive whitelist: agents may emit only directives whose type identifier is in the set; directives with type identifiers outside the set are rejected at validation time.

For example, the cross-instance analytics agent's directive whitelist includes ten directive types: LIST_TEMPLATES, COMPUTE_STATS, CROSS_CORRELATE, CREATE_PIVOT, RUN_CLASSIFICATION, RUN_REGRESSION, VIEW_SHAP, STAGE_ANALYTICS, LINE_ITEM_ANALYTICS, and TEAM_ANALYTICS. An LLM response from this agent that emits a directive with a different type identifier (e.g., DELETE_TEMPLATE, which is not in the whitelist) is rejected; the directive is not executed.

The whitelist enforcement happens at the directive parser layer: as each directive is extracted from the LLM response, the directive's type identifier is checked against the whitelist. Invalid directives are dropped from the parsed directive list; valid directives proceed to schema validation and execution.

The whitelist serves multiple purposes: (a) it prevents the agent from emitting capabilities beyond its policy-evaluated scope, (b) it provides a stable contract for downstream consumers of agent output, (c) it enables capability-grant auditing (a directive type added to the whitelist is visible in the source code review), (d) it constrains the LLM's exploration space, reducing hallucination risk.

### Structured Difference Records for Proposed Mutations

The structured difference records subsystem supports mutations that require human acceptance before execution. The subsystem operates between the agent's mutation proposal and the consumer action handler's execution: proposed mutations are stored as structured diffs, presented to the operator for acceptance, and either executed (on acceptance) or discarded (on rejection).

Each structured diff record carries the action type identifier (specifying which consumer action handler would be invoked on acceptance), the target record identifier (the record that would be mutated), a before-state JSON serialization (the state of the target record at proposal time), an after-state JSON serialization (the proposed post-mutation state of the target record), a proposing agent identifier, a proposing timestamp, a status field (pending, accepted, rejected), the accepting user identifier (set on acceptance or rejection), and the acceptance timestamp.

The subsystem operates in two modes: per-change acceptance (the operator reviews each diff individually and clicks accept or reject) and bulk acceptance (the operator selects multiple diffs and applies a single acceptance action). Bulk acceptance is gated by additional confirmation in the user interface to prevent accidental approval of many changes.

The subsystem's invocation is configurable per action type: action types designated as approval-required route through the subsystem; action types designated as auto-execute proceed directly to the consumer action handler. The approval-required designation is set at deployment time per action type and per policy context.

### Per-Change and Bulk Acceptance UI Controls

The acceptance user interface presents proposed mutation diffs in a structured review surface. Each diff is rendered with the before-state and after-state side-by-side or in a unified diff view. The operator may scan multiple diffs efficiently, accepting routine changes in bulk and reviewing unusual changes individually.

The interface supports filters by action type, by proposing agent, by target record class, and by date range. The filters enable the operator to triage large batches of proposed mutations (e.g., reviewing all AI-proposed scope changes generated during a specific time window).

The interface tracks acceptance state per diff: pending (awaiting decision), accepted (applied), rejected (discarded), expired (no decision within configured time-out, treated as rejected). The state transitions are recorded in the policy decision log for forensic reconstruction.

### Policy Decision Logger Detail

The policy decision logger records, for each AI action request, a structured log entry summarizing the policy evaluation result and the resulting action outcome. Each log entry carries the policy evaluation result (the boolean outcomes of each policy dimension check: tenant AI enablement, license tier match, user permission, party role determination, additional capability credential check), the capability surface generated (the permitted capability set), the agent type and identifier, the agent instantiation outcome (success, failure with reason), the proposed mutations emitted by the agent (count and action types), the mutation execution outcomes (accepted, rejected, executed), the acceptance flow events (if applicable), the requesting user identifier, the request timestamp, and a request identifier for cross-system correlation.

The log entries are persisted in a dedicated policy decision log database table indexed by request identifier, by user identifier, by tenant organization identifier, and by timestamp. The indexed columns support efficient retrospective queries: which decisions were made for a specific user, which decisions were made within a specific time window, which decisions involved a specific agent type.

The policy decision log is append-only: log entries are written once at the conclusion of each AI action request and are never modified. Append-only semantics support the audit trail requirements of regulated deployments.

### Stale Database Connection Cleanup Detail

The stale database connection cleanup subsystem prevents accumulation of idle database connections in the long-running thread pool used by AI agent execution. The cleanup is implemented as a function invoked before and after every thread-pool worker callable.

The cleanup function closes connections that have been idle longer than a configured threshold, releasing them to the connection pool for reuse. The cleanup is idempotent: invoking it on a fresh connection has no effect; invoking it on an idle connection closes the connection.

The cleanup is bracketing: it is invoked before the worker callable runs (cleaning up connections inherited from a previous worker iteration) and after the worker callable completes (cleaning up connections opened by the callable). The bracketing pattern prevents both stale-connection accumulation (which would gradually exhaust the connection pool) and worker-leaked connections (which would tie up connections in the worker even when the worker is idle).

### Thread Pool Executor Detail

The thread pool executor for AI agent execution is implemented as a process-local singleton constructed lazily on first use. The construction parameters include a max-workers count (read from the BACKGROUND TASK MAX WORKERS environment variable, defaulting to 16) and a thread-name prefix for diagnostics.

The executor is rebuilt if the process identifier changes between invocations. Process-identifier change occurs after process fork (e.g., uWSGI worker forking from a master), where the inherited executor's thread pool is no longer valid. The rebuild ensures the executor remains valid across fork boundaries.

The executor exposes a submit interface that accepts a callable and returns a Future. The Future resolves to the callable's return value on completion. The submit interface is awaitable from async code via the framework's asyncio integration.

### Graceful Termination Handler Detail

The graceful termination handler intercepts the SIGTERM operating system signal and drains in-flight work before allowing the process to exit. The handler is registered via the standard signal module to handle SIGTERM during process startup.

On signal receipt, the handler enters a drain loop that polls the executor's work queue depth and the count of active worker threads, sleeping briefly between polls. The loop exits when both the queue is empty and no workers are active. After the drain, the handler invokes the executor's shutdown method with the wait flag set, blocking until all worker threads terminate cleanly.

The drain pattern prevents data loss during deployment rolling restarts. In-flight database mutations complete normally rather than being aborted mid-transaction. AI agent responses are delivered to connected clients before the connection is torn down.

The signal handler is registered only on the main thread (signals are process-level and must be handled by the main thread). The main-thread check prevents accidental handler registration in spawned threads.

### Journey State Evaluation Detail

The journey state evaluation step determines the operational status of the target execution instance for policy decisions. The evaluation examines fields on the execution instance record including isTemplate (true for template records, false for instance records), isArchived (true for archived instances), current_stage (the active stage identifier), and outcome_classification (the outcome assignment if any).

Policy decisions may consult the journey state to constrain capability surfaces: archived instances may expose only read capabilities; template records may expose only template-management capabilities; instances with terminal outcome classifications may expose only audit capabilities; active in-progress instances expose the full capability set.

The journey state evaluation is performed within the policy context builder, after the permission check and before the agent instantiation. The evaluation result is incorporated into the policy context as an additional dimension, enabling capability surface generators to make state-aware capability decisions.

### AI Authorization Flag Retrieval Pattern

The AI authorization flag retrieval pattern queries the tenant organization membership record with a select-related join to retrieve the AI authorization flag in a single database round trip. The pattern is:

(1) Filter the tenant organization membership table by the requesting user. (2) Apply select-related to the membership's org foreign key, joining the tenant organization record into the query. (3) Take the first matching membership record (a user may have membership in at most one tenant organization in the preferred embodiment; if a user has multiple memberships, the first matching record by primary key determines the authorization flag). (4) Read the allowGenAIUse field from the joined organization record.

The single-round-trip pattern avoids the N+1 query anti-pattern that would occur if the membership and organization were queried separately. The performance optimization is meaningful at the millisecond budget the policy gate operates under: an N+1 anti-pattern would double the gate's latency.

The retrieval pattern handles the no-membership case gracefully: if the membership query returns no record, the gate returns the default-permitted result (true), permitting system-level operations to proceed. If the membership record exists but the organization foreign key is null (an unusual state), the gate also returns the default-permitted result. The default-permitted behavior is intentional and documented; downstream consumers may not assume the gate's true result implies a populated organization record.

### Agent Adapter Permission Gate Flow

The full sequence of policy checks performed by the agent adapter:

Step AG-1—Agent discovery. Resolve the agent class from the agent identifier via the filesystem walk and class-name resolution. If no class is found, return an error.

Step AG-2—Scope detection. Classify the resolved agent class as stage-scoped, journey-scoped, or system-scoped based on its filesystem location.

Step AG-3—Journey context load. If a journey identifier is provided, load the execution instance record by identifier. Verify the requesting user is authenticated. If unauthenticated, return None.

Step AG-4—Permission check. Construct a permission checker for the requesting user against the loaded execution instance. Verify the requesting user has at least view-level permission via can View. If permission fails, return None (the agent adapter handler returns without instantiating any agent).

Step AG-5—Branch by scope. For stage-scoped agents, route through the stage controller (which handles its own additional policy checks at the stage level). For journey- and system-scoped agents, proceed to chat-agent handling.

Step AG-6—Payload allowlist filtering. For chat-agent invocations, filter the request payload against the agent class's constructor signature. Drop unknown payload keys. Apply the platinum-tier check for tier-restricted parameters.

Step AG-7—Agent instantiation. Instantiate the agent class with the filtered payload, the user, the loaded execution instance (if applicable), the permission checker, and the agent-specific context.

Step AG-8—Update type dispatch. Dispatch the message's update type to the appropriate agent method (getter, user_message, send_action, run_task, do_action, etc.).

Step AG-9—Policy decision log. Record the full sequence of policy checks and their outcomes in the policy decision log.

The sequence terminates early on any policy check failure: failed checks short-circuit subsequent steps and return an error response to the requesting client. The early termination prevents unnecessary work after a denial is determined.

### Multiple Embodiments—Capability Set Variants

The capability set generator supports multiple alternative configurations:

Capability Embodiment CV-1—Two-tier (host vs guest). The preferred embodiment, with first capability set for first-party members and second capability set for second-party members.

Capability Embodiment CV-2—Three-tier (admin/host/guest). An alternative embodiment that distinguishes administrative first-party members from non-administrative first-party members, exposing tenant-administration capabilities only to administrative members.

Capability Embodiment CV-3—License-tier-stratified. A further alternative embodiment that stratifies the capability set across multiple license tiers within each party role group, producing six or more distinct capability sets (e.g., Guest-tier host, Pro-tier host, Enterprise-tier host, Guest-tier guest, Pro-tier guest, Enterprise-tier guest).

Capability Embodiment CV-4—Fully customizable per-tenant. A further alternative embodiment that supports per-tenant customization of the capability set, with administrative members defining which agent types and which directive types are available to which user classes within their tenant.

### Performance Characteristics

The policy-governed agent execution architecture exhibits the following performance characteristics:

Performance characteristic PC-1—Policy evaluation overhead. The full policy evaluation sequence (steps AG-1 through AG-9) typically completes in single-digit milliseconds for cached configurations. Database queries (tenant organization membership, execution instance permission check) are the dominant latency contributors.

Performance characteristic PC-2—Agent instantiation overhead. Agent instantiation requires class loading (cached after first load), constructor invocation, and context payload assembly. Cached-class instantiation typically completes in sub-millisecond time.

Performance characteristic PC-3—Concurrent agent count. The concurrent agent count is bounded by the thread pool executor's worker count (configurable, defaulting to 16). Excess invocations queue and are processed as workers free.

Performance characteristic PC-4—Policy decision log overhead. Policy decision log writes are asynchronous and do not block the agent invocation path. Log overhead is amortized across multiple invocations through batch writes.

### Method-Form Embodiment

In an embodiment, the present invention is embodied as a computer-implemented method:

Method step M-1—Receive AI action request. Receive an AI action request identifying an agent type and a requesting user.

Method step M-2—Discover agent class. Discover the agent class from the agent type identifier.

Method step M-3—Detect scope. Detect the agent's scope category (stage, journey, or system).

Method step M-4—Assemble policy context. Assemble the multi-dimensional policy context (tenant AI enablement, license tier, user permission, party role).

Method step M-5—Evaluate pre-context permission gate. Evaluate the gate before any execution-object data is loaded.

Method step M-6—Filter request parameters. Filter the request payload through the allowlist; verify additional capability credentials for tier-restricted parameters.

Method step M-7—Determine permitted capability set. Determine the permitted capability set based on the policy context.

Method step M-8—Generate agent system prompt. Generate the agent system prompt incorporating only the permitted capability set.

Method step M-9—Instantiate the agent. Instantiate the agent class within the policy-evaluated execution envelope.

Method step M-10—Route proposed mutations. Route each proposed mutation through the handler registry, directive whitelist, and party-specific mutation gate.

Method step M-11—Route approval-required mutations. Route approval-required mutations to the acceptance flow before execution.

Method step M-12—Log policy decision. Log the policy evaluation result, capability surface, and action outcome.

### INDUSTRIAL APPLICABILITY

The policy-governed agentic action control architecture has industrial applicability in any multi-tenant SaaS deployment that exposes AI agents to users with differentiated capability requirements. Specific industries include enterprise SaaS platforms, regulated workflow automation (healthcare, finance, legal), multi-stakeholder collaboration tools, and platform marketplaces with first-party and third-party developer ecosystems.

1. A policy-governed agent execution system comprising: an agent request receiver configured to receive an AI action request identifying an agent type and a requesting user; an agent discovery module configured to identify an agent implementation corresponding to the agent type from a set of registered or discoverable agent definitions; a policy context builder configured to assemble, for the AI action request, a policy context comprising at least: a tenant AI enablement status derived from a tenant organization record, a license tier of the requesting user, a permission evaluation of the requesting user against a target execution object, and a party role group membership of the requesting user; a pre-context permission gate configured to evaluate the policy context before any execution-object data is loaded into an AI context payload, and to terminate the AI action request without constructing any context payload when the permission evaluation fails, wherein terminating the AI action request prevents execution-object data from being transmitted to a language model for the AI action request; a payload parameter filter configured to filter parameters of the AI action request through an allowlist of permitted parameters, discard parameters not present in the allowlist before agent instantiation, and require verification of an additional capability credential for a restricted subset of permitted parameters; and an agent instantiation module configured to instantiate the identified agent class with only the permitted context, permitted parameters, and permitted execution-object data, such that the agent operates within a policy-evaluated execution envelope.

2. A system for generating policy-governed AI capability surfaces comprising: a capability surface generator configured to, for each AI action request, determine a permitted capability set based on at least: the requesting user's party role group membership, the requesting user's license tier, and a tenant-level AI policy; wherein for a requesting user belonging to a first party role group with a qualifying license tier, the capability surface generator exposes a first capability set comprising creation tools, sharing directives, analytics capabilities, and team management functions; wherein for a requesting user belonging to a second party role group, the capability surface generator exposes a second capability set comprising navigation assistance and engagement guidance scoped to execution objects visible to the requesting user, and suppresses creation tools, sharing directives, and analytics capabilities; wherein for a requesting user whose tenant has AI disabled, the capability surface generator suppresses agentic AI action capabilities; and a prompt assembly module configured to generate an agent system prompt incorporating only the permitted capability set, such that the AI agent is not aware of suppressed capabilities, and wherein the system enforces the permitted capability set by excluding non-permitted tools or directives from invocation by the AI agent and by rejecting directives outside the permitted capability set at a directive validation boundary.

3. A policy-gated AI action execution system comprising: a handler registry comprising a plurality of registered action handlers, each action handler associated with a specific mutation type on a shared execution object; a directive whitelist comprising a predetermined set of permitted directive types for a given agent type; a party-specific mutation gate configured to evaluate, for each proposed AI-driven mutation, whether the mutation type is restricted to a specific party role group, and to reject the mutation when the requesting user does not belong to the required party role group; an approval routing module configured to, for proposed mutations designated as requiring human acceptance, store the proposed mutation as a structured proposal, present the proposal to an authorized user for acceptance or rejection, and execute the mutation only upon explicit acceptance; and a policy decision logger configured to record, for each AI action request, the policy dimensions evaluated, the capability surface generated, the action permitted or denied, and the execution outcome.

4. A computer-implemented method for policy-governed AI agent execution, the method comprising: receiving an AI action request identifying an agent type and a requesting user; assembling a policy context comprising tenant AI enablement status, license tier, user permissions against a target execution object, and party role group membership; evaluating the policy context before loading any execution-object data, and terminating the request when the permission evaluation fails; filtering parameters of the AI action request through an allowlist and discarding non-allowlisted parameters; verifying an additional capability credential for tier-restricted parameters; determining a permitted capability set based on party role group, license tier, and tenant policy; generating an agent system prompt incorporating only the permitted capability set; instantiating the agent with permitted context, permitted parameters, and the capability-scoped system prompt; routing each proposed AI-driven mutation through a handler registry, directive whitelist, and party-specific mutation gate; routing approval-required mutations to an acceptance flow before execution; and logging the policy evaluation result, capability surface, and action outcome.

5. The system of claim 1, wherein the agent discovery module resolves the agent class by converting a snake-case agent type identifier to a PascalCase class name and importing the corresponding module from a predefined agent directory, and wherein the agent discovery module detects whether the agent is a stage-scoped agent, a journey-scoped agent, or a system-scoped agent based on the agent's directory location.

6. The system of claim 1, wherein the tenant AI enablement status is derived from an AI authorization flag on a tenant organization record associated with the requesting user, and wherein when the AI authorization flag is inactive, the pre-context permission gate terminates the AI action request for all agent types.

7. The system of claim 1, wherein the payload parameter filter maintains a first allowlist of generally permitted parameters and a second allowlist of tier-restricted parameters, and wherein tier-restricted parameters are forwarded to the agent only when the requesting user's license tier satisfies a predetermined tier requirement.

8. The system of claim 1, wherein the pre-context permission gate evaluates permission by loading the target execution object and verifying that the requesting user has at least view-level permission via a party-aware permission evaluator before any execution-object data is exported to the AI context payload.

9. The system of claim 2, wherein the first capability set further comprises AI-driven invitation management directives configured to generate guest invitation links, transmit invitation emails, add team members, and revoke unused invitations, each directive gated by a per-journey sharing policy matrix.

10. The system of claim 2, wherein the prompt assembly module generates different system prompts for the same agent type based on the requesting user's policy context, such that two users invoking the same agent type receive different AI capabilities.

11. The system of claim 3, wherein the handler registry rejects any proposed mutation whose action type is not registered, preventing AI agents from executing arbitrary database operations.

12. The system of claim 3, wherein the party-specific mutation gate identifies at least one mutation type as restricted to the first party role group, comprising scope-related mutations, and permits other mutation types by any authorized member of either party role group.

13. The system of claim 3, wherein the approval routing module stores proposed mutations as structured difference records comprising a before-state and an after-state for each affected field, and presents the difference records through the user interface with per-change and bulk acceptance or rejection controls.

14. The system of claim 1, wherein the policy context builder further evaluates the journey state of the target execution object, such that the permitted capability set may differ based on whether the execution object is in an active, completed, or archived state.

15. The system of claim 1, wherein the agent instantiation module closes stale database connections before and after agent execution to prevent connection leakage across concurrent agent invocations in a thread pool.

16. The system of claim 1, further comprising a graceful termination handler configured to, upon receiving a system termination signal, drain pending AI action requests before shutting down, such that in-flight policy-evaluated agent executions complete without data loss.

17. The method of claim 4, wherein when the AI action request fails at any policy evaluation step, the method terminates without constructing any AI context payload, without invoking any large language model, and without executing any mutation on the target execution object.

18. The system of claim 1, wherein each registered action handler reachable through the agent execution envelope is associated with a permission-tier identifier drawn from an enumerated set of permission tiers, and wherein the system, prior to invoking a resolved action handler in response to an AI-driven action request, consults the permission-tier identifier of the resolved action handler and verifies that the requesting user holds at least the corresponding permission tier, such that the permission tier required to invoke a given action is a structural property of the action-type rather than a property of the user, the handler implementation, or the requesting client, and wherein the permission tier mapping is enforced at the dispatch boundary independent of any logic within the handler implementation.

19. The system of claim 1, wherein the policy context builder is configured to return a null context result when the pre-context permission gate evaluation fails, and wherein the agent instantiation module is configured to abort on a null context result before any execution-object data is loaded into a context payload, before any large language model is invoked, and before any agent class is instantiated, such that no probabilistic generative model context is constructed and no model invocation occurs in the absence of a passing permission evaluation.
